(19) United States
(12) Patent Application Publication
(10) Pub. No.: US 2017/0326834 A1
(43) Pub. Date: Nov. 16, 2017

(54) TEXTILE REINFORCEMENT FOR PULTRUSION AND METHOD FOR THE PRODUCTION THEREOF

(71) Applicant: Gilbert Chomarat, Cologny (CH)

(72) Inventor: Gilbert Chomarat, Cologny (CH)

(21) Appl. No.: 15/528,147

(22) PCT Filed: Dec. 8, 2015
(86) PCT No.: PCT/IB2015/059439

§ 371 Date: May 19, 2017

(30) Foreign Application Priority Data
Dec. 8, 2014 (FR) 14 62086

(51) Int. Cl. B32B 5/08; B32B 5/06; D04H 3/10; D04H 3/12; B29C 70/08; B32B 5/10; B29C 70/24

(52) U.S. Cl. CPC B32B 5/08; B29C 70/081; B32B 5/06; B32B 5/10; D04H 3/10; D04H 3/12; B32B 2250/20; B29C 70/24; B32B 2255/02; B32B 2262/0276; B32B 2262/101; B32B 2307/52; B32B 2307/558; B32B 2255/24

(57) ABSTRACT

Textile reinforcement that can be used for the production of composite parts by pultrusion, including a central layer made from glass fibre segments and polyester, and in which, in the central layer, the glass fibre segments are enrobed with polyester, the central layer including a central reinforcement core surrounded by the glass fibre segments enrobed with polyester, at least one fibre-web surface layer forming one of the external faces of the textile reinforcement.

### TECHNICAL FIELD OF THE INVENTION

The present invention concerns textile reinforcements used as products for strengthening of composite articles, that is, articles based on resin (polyester or another one) strengthened with a textile reinforcement.

More especially the invention concerns textile reinforcements intended to make composite articles by a pultrusion process.

Pultrusion is a method of continuous shaving of plastics, including strengthening elements, having a constant cross section. During the pultrusion process, the product is drawn through a spinneret during which the reinforcing elements are overmolded and impregnated with a resin. The resin is generally a thermosetting plastic. The spinneret itself is heated. After leaving the spinneret and cooling down, the product is cut to the desired lengths, thus forming profiled composite articles strengthened by the reinforcement elements.

The reinforcement elements are generally composed of fibers, and thus form a continuous textile reinforcement.

In its passage through the pultrusion spinneret, the continuous textile reinforcement is subjected to braking forces, and it is necessary to place it under tension to ensure that it holds its shape. Thus, the pulling of the textile reinforcement through the spinneret requires the applying of longitudinal driving forces to the continuous textile reinforcement, basically in traction.

At the same time, since pultrusion is a continuous process, it needs to use a continuous textile reinforcement, thus having a much larger longitudinal dimension than its transverse dimensions. As a result, under the action of a traction force, such an initially flat continuous textile reinforcement has a tendency to be deformed, producing undulations in the transverse direction, in the same way as a necktie is deformed when pulled downward. If such a deformation of the textile reinforcement occurs prior to entering the pultrusion spinneret, it will reduce the width of the reinforcement and is liable to produce folds. This deformation of the reinforcement, and the resulting risks of defects, are more likely to occur when the reinforcement has a large width in relation to its thickness.

Continuous textile reinforcements which are based on continuous glass fibers are known, which are of interest in that they confer a great mechanical strength on the products made by overmolding of these reinforcements, thanks to the advantageous properties of glass fiber. These continuous reinforcements are generally in the form of a flat band. For example, one method of making such a continuous reinforcement is specified in the document U.S. Pat. No. 3,969,171: the glass filaments exiting from a glass extrusion spinneret are assembled to produce glass threads which will be deposited in random fashion in every orientation on a conveyor belt. A binder is sprayed onto the glass threads, and then treated in an oven. This method is not able to control the direction of mechanical strength provided by the presence of the continuous glass threads and it does not provide a sufficient longitudinal mechanical strength for a pultrusion application.

Document WO 95/34703 A1 describes a textile reinforcement for making composite parts by pultrusion. This reinforcement comprises a layer based on glass fibers and polyester, in which the glass fibers are in the form of pieces of glass fiber coated with polyester and oriented in random fashion. When this reinforcement is used in a pultrusion process, the reinforcement needs to combined with continuous longitudinal filaments (rovings) and exterior webs, the continuous longitudinal filaments having the function of conferring a sufficient mechanical resistance to elongation on the reinforcement to withstand the traction during the pultrusion. This significantly complicates the pultrusion process due to the need to assemble and hold several elements in position in the spinneret. Moreover, with such a reinforcement structure it proves difficult to make profiles by pultrusion having a large width (at least 30 cm) and an acceptable quality, especially an acceptable transverse mechanical strength.

For these reasons in particular, the textile reinforcements which have been proposed thus far do not have a satisfactory structure which can withstand a pultrusion process and produce relatively wide profiled pieces.

### EXPLANATION OF THE INVENTION

One problem proposed by the present invention is thus to design a new structure of textile reinforcement which is particularly adapted to pultrusion processes, due to the fact that it has both good strength in longitudinal traction and good resistance to transverse deformations which are liable to occur during a pultrusion process, so that the textile reinforcement can be used during the pultrusion process without adding other strengthening elements such as continuous longitudinal threads in the spinneret.

Another problem proposed by the present invention is to design a method and a device for producing a new structure of textile reinforcement based on glass fiber which is perfectly adapted to pultrusion processes.

In order to accomplish these as well as other goals, the invention proposes a textile reinforcement which can be used to make composite parts by pultrusion, comprising a central layer having segments of glass fiber coated with polyester, and in which:
the central layer furthermore comprises a central reinforcement core, which is able to provide a longitudinal and transverse reinforcement, and which is surrounded by the segments of glass fiber coated with polyester,
at least one surface layer of fiber web forms one of the outer surfaces of the textile reinforcement.

Due to the fact that the glass fiber segments of the central layer are coated with polyester and surround the central reinforcement core, the textile reinforcement has good resistance to transverse deformations during a pultrusion process.

The central reinforcement core allows the textile reinforcement to be given mechanical strength properties in the longitudinal direction and in the transverse direction. This significantly distinguishes the reinforcement according to the present invention from the reinforcements customarily used in the pultrusion techniques, which are basically formed of threads oriented in every direction and in random fashion. Such a known reinforcement necessarily has an insufficient longitudinal mechanical strength, requiring the adding of longitudinal glass fibers at the time of the pultrusion. But this adding of longitudinal glass fibers does not participate in the transverse mechanical strength of the reinforcement, which remains insufficient.

According to the invention, the central reinforcement core, structured so as to furthermore give the textile reinforcement properties of mechanical strength in the transverse direction, makes it possible to produce reinforcements of greater width, which are suitable to then make profiled pieces of great width by pultrusion, without the risk of untimely deformation.

The surface layer of fiber web forms a smooth outer surface, which can confer a particularly smooth and finished surface state on the composite part made by pultrusion based on the reinforcement thus constituted. In fact, the surface layer of fiber web, formed from relatively fine fibers, has a smooth appearance and hides the fibers of the central reinforcement layer. At the same time, the surface layer of fiber web forms an external reinforcement surface which facilitates the manufacturing of the reinforcement in that it avoids the gluing of the reinforcement during the course of its manufacture on a conveyor belt.

Moreover, the surface layer of fiber web can itself be made of colored fibers, which then give to the resulting pultruded products a colored appearance taking on the color of the surface layer of fiber web. Colored parts can thus be produced, and the changes in color from one production to another can be very easy by simply changing the surface layer of fiber web, without having to perform complex and costly cleaning of the spinneret, for example, in order to change the color of the resin injected into the spinneret.

Preferably, the glass fiber segments in the central layer are pieces of fiber obtained from ravings of glass thread, which are commonly available products.

The glass fiber segments in the central layer may advantageously comprise glass threads having a linear weight of 40 to 50 tex, that is, of 40 to 50 grams per kilometer of thread. The glass fiber ravings can have a linear weight of 600 to 2400 tex.

Preferably, the polyester that coats the glass fiber segments in the central layer is an unsaturated bisphenol polyester, soluble or insoluble in styrene. This facilitates its melting to coat the glass fibers during the manufacture of the textile reinforcement.

In practice, the central reinforcement core can be formed of fibers structured by weaving, or by a grid, or by single threads oriented in appropriate manner, for example longitudinal threads, or an assemblage of longitudinal threads and transverse threads.

Preferably, the threads or fibers making up the central reinforcement core are secured to each other, which facilitates the guiding and the penetration of the strengthening elements in the pultrusion spinneret.

In the case of a grid, disjointed weft threads and disjointed warp threads are crisscrossed to form loose meshes, and are attached to one another by gluing at their junction points.

The benefit of a central core structured as a grid is to ensure both good mechanical strength in the longitudinal direction and in the transverse direction, and to benefit from the very low cost of production of such a grid.

The fibers forming the central core can advantageously be continuous glass threads, which can have an individual linear weight of 66 to 272 tex. Alternatively, ravings of continuous glass threads can be used, said rovings having a linear weight of the roving of 320 to 1200 tex.

In another embodiment, the textile reinforcement according to the invention may comprise two surface layers of fiber web, said surface layers forming the two external faces of the textile reinforcement.

The surface layers can be made of polyester, polyamide, or polypropylene, it being noted that these are formed by a material whose melting point is higher than that of the polyester resins of the central layer, for example, a melting point on the order of 250° C.

In the central layer, the glass fiber segments can advantageously have a length of 40 to 120 mm. A good compromise is thus made between the ability of the fibers to be oriented in every direction in random fashion inside the textile reinforcement and the ability of the fibers to provide the textile reinforcement with great mechanical strength.

In practice, it could be arranged for the glass fiber segments to be present in the central layer in a quantity of 150 to 2000 g per square meter.

Furthermore, in the central layer the polyester could be present in a quantity of 3 to 5% by weight of the glass fibers.

According to another aspect, the present invention proposes a method of fabrication of a textile reinforcement usable in making composite parts by pultrusion, involving the following consecutive steps:
a) on top of a conveyor belt moving in the longitudinal direction, arrange a first web of fibers made of polyester, polyamide or polypropylene,
b) cut rovings of glass fiber and let them drop onto a first pin roller at the same time receiving a polyester powder, making drop onto said first web placed on the moving conveyor belt a first mixture of segments of glass fiber and polyester powder, the polyester powder being chosen so as to have a melting point lower than that of the fibers making up the first web,
c) arrange a reinforcement core of reinforcing fibers on the first mixture of glass fiber segments and polyester powder,
d) cut ravings of glass fiber and let them drop onto a second pin roller at the same time receiving a polyester powder, making drop onto said reinforcement core of reinforcing fibers a second mixture of glass fiber segments and polyester powder,
f) heat the assemblage by passing through an oven so as to melt the polyester powder and ensure its distribution around the glass fiber segments, yet without melting the fibers of the first web.

A particularly simple and economical method of making the textile reinforcement for pultrusion is thus realized.

In this way, advantageous mechanical properties can also be conferred on the textile reinforcement by selecting the orientation of the reinforcing fibers in the core.

Advantageously, prior to step f), an intermediate step e) can be provided consisting in depositing, on said second mixture of glass fiber segments and polyester powder, a second web of polyester, polyamide, or polypropylene, thus constituting a second external surface without glass fibers.

The first web can advantageously be obtained by carding, and have a surface density of 20 to 40 g per square meter.

Preferably, the polyester powder used to make the central layer can consist of an unsaturated bispherol polyester resin, soluble or insoluble in styrene, and in a quantity of 3 to 5% by weight of the glass fiber segments.

In practice, the polyester powder used in the central layer may have the property of melting when subjected to a temperature of 100° C. for two minutes.

Moreover, the polyester powder may be in the form of a dry powder or in the form of a powder emulsion in water.

The polyester web(s) used to make the external surface(s) may advantageously be colored, conferring on the reinforcement, and then on the pultruded material made from the reinforcement, a coloration in the mass, resistant to outside attack, without the need for supplemental coloring of the pultruded material itself.

### DESCRIPTION OF THE DRAWINGS

Other objects, characteristics and advantages of the present invention will emerge from the following description of particular embodiments, given in regard to the enclosed figures, in which:

FIG. 1 is a schematic side view in longitudinal section of a textile reinforcement according to a first embodiment of the invention;

FIG. 2 is a schematic view in transverse section of the textile reinforcement of FIG. 1;

FIG. 3 is a schematic side view in longitudinal section of a textile reinforcement according to a second embodiment of the invention;

FIG. 4 is a schematic view in transverse section of the textile reinforcement of FIG. 3;

FIG. 5 is a schematic top view of the textile reinforcement according to any of the preceding figures;

FIG. 6 is a schematic side view illustrating a device and a method for making the textile reinforcement of FIGS. 1 to 5.

### DESCRIPTION OF PREFERRED EMBODIMENTS

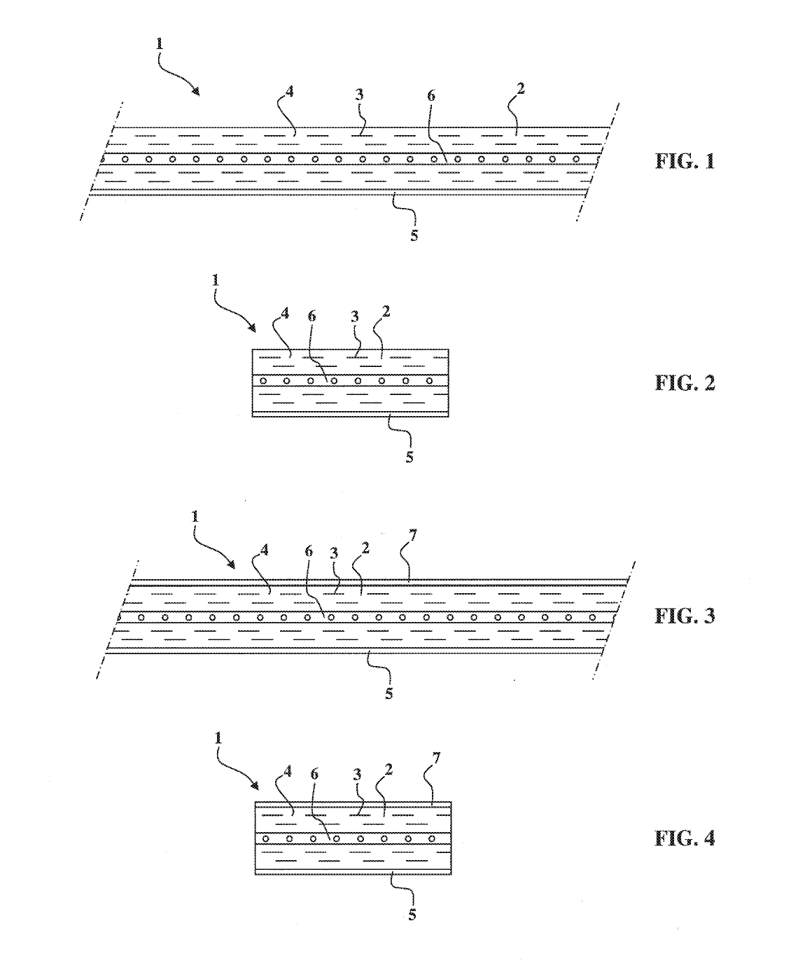

In the embodiment illustrated in FIGS. 1 and 2, the textile reinforcement 1 comprises a central layer 2 based on segments of glass fiber 3 coated with polyester 4. A surface layer 5, of fiber web, forms one of the external faces of the textile reinforcement 1, in the present instance, the lower external face.

The glass fiber segments 3 are rovings of single-strand thread pieces, having a linear weight of 40 to 50 tex, and oriented in random manner between the longitudinal direction and the transverse direction of the textile reinforcement 1.

The polyester 4 coating the glass fiber segments 3 is an unsaturated bisphenol polyester, whose melting point is on the order of 100° C., lower than the melting point of the synthetic material composing the surface layer 5.

The surface layer 5 may be made of polyester, polyamide, or polypropylene, reserving the fact that its melting point is higher than that of the polyester making up the central layer 2. A melting point of the fibers of the surface layer 5 can be, for example, around 250° C.

The central layer 2 moreover comprises a central core of longitudinal reinforcement 6, which is surrounded on its two principal faces by the glass fiber segments 3 coated with polyester 4.

In the embodiment illustrated in FIGS. 1 and 2, the central core of longitudinal reinforcement 6 is formed of fibers basically oriented in the longitudinal direction and in the transverse direction of the textile reinforcement 1.

In order to guarantee good mechanical strength under longitudinal traction, the central core of longitudinal reinforcement 6 basically consists of longitudinal threads. The polyester surrounding the glass fibers ensures a good mechanical strength resisting the transverse deformation of the reinforcement.

In order to guarantee at the same time a good mechanical strength in the transverse direction of the reinforcement, the central core of longitudinal reinforcement 6 is formed of fibers structured by weaving, or by a grid, thus comprising warp threads and weft threads. The advantage of the grid is that it is more easy and quick to produce than the weaving.

Preferably, the fibers in the central core of longitudinal reinforcement 6 are secured to each other, by gluing, to facilitate the passage through the pultrusion spinneret when the textile reinforcement 1 is used to make a profiled piece by pultrusion.

A textile reinforcement 1 according to the invention with central core comprising warp threads and weft threads provides a satisfactory mechanical strength not only in the longitudinal direction but also in the transverse direction, allowing such a textile reinforcement 1 to be used to make profiled pieces of greater width.

In the second embodiment, illustrated in FIGS. 3 and 4, the elements of the embodiment of FIGS. 1 and 2 are found again. Thus, the central layer 2, the glass fibers 3, the polyester 4, the lower surface layer 5, the central core of longitudinal reinforcement 6 are found. The difference lies in the additional presence of a second surface layer 7 of fiber web forming the second external face of the textile reinforcement 1, namely, the upper surface in the illustrated case.

The second surface layer 7 can be composed of the same synthetic material as the first surface layer 5.

At least one of the two surface layers 5 and 7 can itself be colored in the mass.

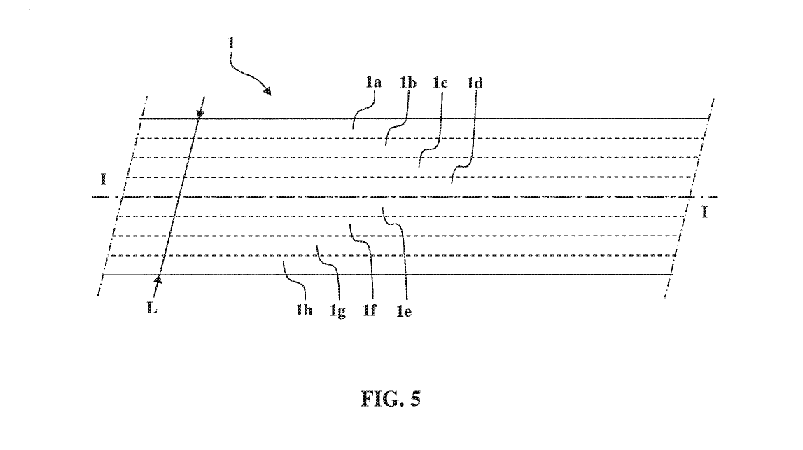

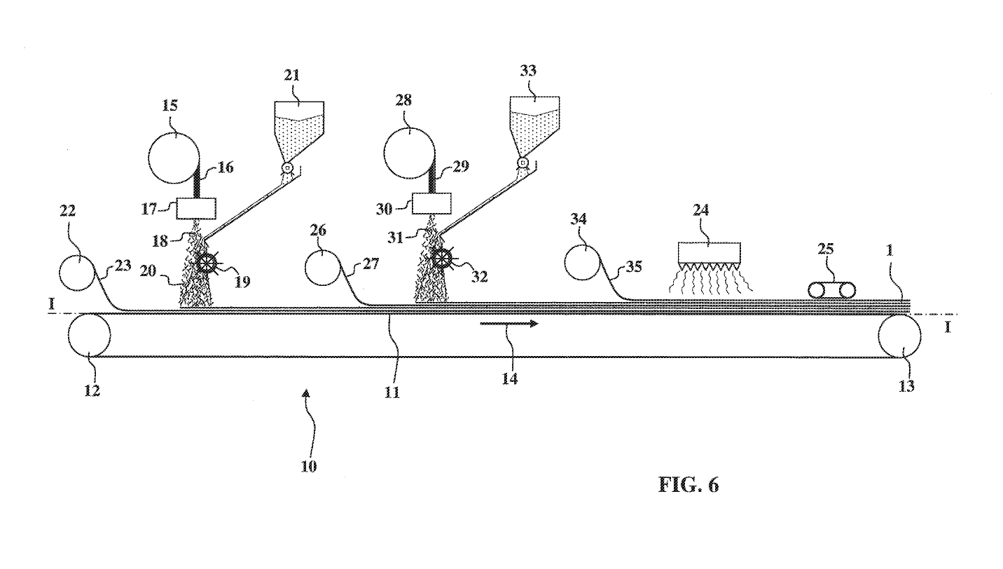

As can be seen in FIG. 5 in top view, the textile reinforcement according to the invention can be fabricated in the form of a wide band, extending longitudinally along an elongation axis I-I, and of width L consistent with the manufacturing capacities of the customary apparatus for production of textile reinforcements. For example, the width L may be around 2 to 3 m, while the length along the axis I-I may be much greater, and the reinforcement may be wound on a reel.

In this figure, the fact is illustrated that the textile reinforcement 1 can then be sliced longitudinally along the dotted lines to form bands 1a, 1b, 1c, 1d, 1e, 1f, 1g, and 1h, each of them constituting a pultrusion reinforcement to make a profiled piece.

Now considering FIG. 6, which represents schematically a device for the fabrication of a textile reinforcement 1 according to the present invention and at the same time illustrates the method of fabrication of the textile reinforcement 1.

The device 10 represented in this figure comprises a conveyor belt 11, for example in the form of a conveyor band moving between an entry roller 12 and an exit roller 13 in a longitudinal direction I-I as shown by the arrow 14. Near the entry roller 12, above the conveyor belt 11, there is located a first distributor of glass fiber rovings 15 which can deliver glass fiber rovings 16 to a first chopper 17. The pieces of glass fiber rovings 18 emerging from the first chopper 17 are sent to a first pin roller 19 which breaks up the pieces of glass fiber rovings to produce glass fiber segments 20. At the same time, a first powder distributor 21 distributes a polyester powder on the first pin roller 19, which first pin roller 19 at the same time accomplishes the mixing of the powder with the glass fiber segments 20.

Upstream from the first pin roller 19 there is provided a first web distributor 22 to generate a first web 23 and to arrange it on the conveyor belt 11.

Furthermore, downstream from the first pin roller 19, there is provided a core distributor 26, which arranges a reinforcement core 27 on the first mixture of fiber segments and powder already present on the conveyor belt 11.

Downstream from the core distributor 26 there is provided a second distributor of glass fiber rovings 28 which delivers ravings of glass fiber 29 to a second chopper 30, which itself delivers pieces of glass fiber ravings 31 to a second pin roller 32, which itself breaks up the pieces of glass fiber ravings and mixes them with a polyester powder received from a second powder distributor 33 and lets them drop onto the longitudinal reinforcement core 27, forming a second mixture.

Downstream on the conveyor belt 11 there is provided an oven 24 able to heat the elements placed on the conveyor belt 11, and downstream from the oven 24 there are one or more pressing rollers 25 able to press the materials moving on the conveyor belt 11.

The oven 24 can be adjusted for example to a temperature of around 180° C., and the speed of movement of the conveyor belt 11 can be such that the heating produced by the oven 24 is sufficient to melt the polyester powder, yet low enough to prevent a melting of the other components of the reinforcement.

Thus, during the fabrication of the textile reinforcement 1 by the device 10, a first polyester web 23 is arranged on top of the conveyor belt 11 moving in the longitudinal direction I-I. With the first chopper 17, ravings of glass fiber 16 are chopped and made to drop onto the first pin roller 19, which at the same time receives the polyester powder coming from the first powder distributor 21. The glass fiber segments 20 mixed with the polyester powder drop onto the first web 23, itself having been placed on the moving conveyor belt 11, forming first mixture. The core distributor 26 arranges on the first mixture the longitudinal reinforcement core 27, and then the second chopper 30, the second powder distributor 33 and the second pin roller 32 produce and deposit on the longitudinal reinforcement core 27 a second mixture of pieces of glass fiber ravings and polyester powder. During the passage through the oven 24, the polyester powder melts and is distributed around the glass fiber segments. The pressing rollers 25 encourage the formation of a sheet of constant thickness by pressing the melted powder on the glass fiber segments. The result at the exit of the device is a textile reinforcement 1 according to the embodiment of FIGS. 1 and 2.

Downstream from the second pin roller 32 there can be provided a second web distributor 34, which supplies a web 35 and places it on the assemblage of components present on the conveyor belt 11. After passing through the oven 24 and the pressing rollers 25, a textile reinforcement 1 according to the embodiment of FIGS. 3 and 4 is obtained.

As a preferred example, the polyester powder may be an unsaturated bisphenol polyester resin. Such a powder is a commercially available product, for example, from COIM SPA with the reference FILCO 661.

Alternatively, the polyester powder may be an unsaturated bisphenol polyester resin used in an aqueous emulsion, such as the ones commercially available from COIN SPA with the references FILCO 657 or FILCO 659. Its drying temperature is 170 to 200° C. for 40 to 70 seconds. After cross linking, it becomes insoluble in styrene and acquires its bonding ability.

The present invention is not limited to the embodiments which have been explicitly described, and instead it includes the different variants and generalizations thereof contained in the scope of the following claims.

1-19. (canceled)

20. A textile reinforcement which can be used to make composite parts by pultrusion, comprising a central layer having segments of glass fiber coated with polyester,
wherein:
the central layer furthermore comprises a central reinforcement core, surrounded by said segments of glass fiber coated with polyester,
at least one surface layer of fiber web forms one of the outer surfaces of the textile reinforcement.

21. The textile reinforcement as claimed in claim 20, wherein the glass fiber segments in the central layer are pieces of fiber obtained from rovings of glass thread.

22. The textile reinforcement as claimed in claim 20, wherein the glass fiber segments in the central layer comprise glass threads having a linear weight of 40 to 50 tex (40 to 50 grams per kilometer of thread).

23. The textile reinforcement as claimed in claim 20, wherein the polyester coating the glass fiber segments in the central layer is an unsaturated bisphenol polyester, soluble or insoluble in styrene.

24. The textile reinforcement as claimed in claim 20, wherein the central reinforcement core (6) is formed of fibers structured by weaving, or by a grid, or by longitudinal and transverse threads.

25. The textile reinforcement as claimed in claim 24, wherein the fibers forming the central reinforcement core are continuous glass threads having an individual linear weight of 68 to 272 tex.

26. The textile reinforcement as claimed in claim 24, wherein the fibers forming the central reinforcement core are rovings of continuous glass threads and have a linear weight of the roving of 320 to 1200 tex.

27. The textile reinforcement as claimed in claim 20, wherein it comprises two surface layers of fiber web, forming the two external faces of the textile reinforcement.

28. The textile reinforcement as claimed in claim 20, wherein the surface layer(s) is/are made of polyester, polyamide, or polypropylene, having a melting point higher than that of the polyester present in the central reinforcement layer.

29. The textile reinforcement as claimed in claim 20, wherein, in the central layer, the glass fiber segments have a length of 40 to 120 mm.

30. The textile reinforcement as claimed in claim 20, wherein the glass fiber segments are present in the central layer in a quantity of 150 to 2000 g per square meter.

31. The textile reinforcement as claimed in claim 20, wherein in the central layer the polyester is present in a quantity of 3 to 5% by weight of the glass fibers.

32. A method of fabrication of a textile reinforcement usable in making composite parts by pultrusion, involving the following consecutive steps:
a) on top of a conveyor belt moving in the longitudinal direction (I-I), arranging a first web of fibers made of polyester, polyamide or polypropylene,
b) cutting rovings of glass fiber and letting them drop onto a first pin roller at the same time receiving a polyester powder, making drop onto said first web placed on the moving conveyor belt a first mixture of segments of glass fiber and polyester powder, the polyester powder being chosen so as to have a melting point lower than that of the fibers making up the first web,
c) arranging a reinforcement core of reinforcing fibers on the first mixture of glass fiber segments and polyester powder,
d) cutting rovings of glass fiber and letting them drop onto a second pin roller at the same time receiving a polyester powder, making drop onto said reinforcement core of reinforcing fibers a second mixture of glass fiber segments and polyester powder,
f) heating the assemblage by passing through an oven so as to melt the polyester powder and ensure its distribution around the glass fiber segments, yet without melting the fibers of the first web (23).

33. The method as claimed in claim 32, comprising, prior to step f), an intermediate step e) consisting in depositing, on said second mixture of glass fiber segments and polyester powder, a second web of polyester, polyamide, or polypropylene.

34. The method as claimed in claim 32, wherein the first web is obtained by carding and has a surface density of 20 to 40 g per square meter.

35. The method as claimed in claim 32, wherein the polyester powder used to make the central layer consists of an unsaturated bisphenol polyester resin, soluble or insoluble in styrene, in a quantity of 3 to 5% by weight of glass fiber segments.

36. The method as claimed in claim 32, wherein the polyester powder has the property of melting when subjected to a temperature of 100° C. for two minutes.

37. The method as claimed in claim 32, wherein the polyester powder is in the form of a dry powder or in the form of a powder emulsion in water.

38. The method as claimed in claim 32, wherein a colored polyester web is used.
